(19) United States
(12) Patent Application Publication
(10) Pub. No.: US 2004/0126180 A1
(43) Pub. Date: Jul. 1, 2004

(54) Combined binder and file system

(76) Inventor: Roni Pelleg, Woodland Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/361,367

(22) Filed: Feb. 10, 2003

Related U.S. Application Data
(60) Provisional application No. 60/354,988, filed on Feb. 8, 2002.

(51) Int. Cl. B42D 3/00

(52) U.S. Cl. 402/73

(57) ABSTRACT

A document case includes a first side panel, a second side panel, and a central section panel. The central section panel joins the first side panel and the second side panel such that the panels may be brought into a facing and spaced apart relationship. A closure can couple the panels and hold them in the facing relationship. An expandable file module with a plurality of interconnected pockets is attached to the first side panel.

### CROSS REFERENCE TO RELATED APPLICATIONS

This non-provisional United States (U.S.) patent application claims the benefit of U.S. Provisional Application No. 60/354,988 filed on Feb. 8, 2003 by inventor Roni Pelleg entitled “Combined Binder and File System.”

### FIELD OF INVENTION

The present invention relates to a container for organizing paperwork and the like, and more particularly to a system comprising an expandable file module and a binder.

### BACKGROUND OF THE INVENTION

It is often desirable to provide a plurality of functions in a portable case containing an expandable file. One such function is carry additional items in the case. Difficulties may arise in provision of the additional functionality when including a binder in the case. These difficulties may be due to additional complexity in manufacture. They may be due to the manner in which the binder is included with the expandable file so as to make access to the file more difficult while using the binder.

### SUMMARY OF THE INVENTION

Briefly stated, in accordance with the present invention, there is provided a system comprising a document case incorporating expandable files supported to one side of a closable case and a binder removable or fixedly secured to an opposite side of the case. A bendable section of the case is intermediate the two sides.

### BRIEF DESCRIPTION OF THE DRAWINGS

The invention, both as to its organization and manner of operation. may be further understood by reference to the following drawings taken in connection with the following description.

Of the drawings:

FIG. 1 is a perspective view of an embodiment of a system constructed in accordance with the present invention having a zipper closure;

FIG. 2 is a plan view of the embodiment of FIG. 1;

FIG. 3 is a plan view of another embodiment of a system constructed in accordance with the present invention having a zipper closure;

FIG. 4 is a plan view of the embodiment of FIG. 3 illustrating modularity of a wire bound binder with respect to the system of FIG. 3;

FIG. 5 is a plan view of another embodiment of a system constructed in accordance with the present invention and closable with a Velcro® strip;

FIG. 6 is a plan view of an embodiment similar to that of FIG. 5, but including a further storage compartment;

FIG. 7 is a view of the embodiment of either FIG. 5, FIG. 6, or FIG. 8 with the side panels in a facing relationship;

FIG. 8 is a plan view of a further embodiment a of system constructed in accordance with the present invention illustrating the zipper; and

FIG. 9 is a plan view of a the embodiment of FIG. 8 utilizing the Velcro® closure.

### DETAILED DESCRIPTION OF THE INVENTION

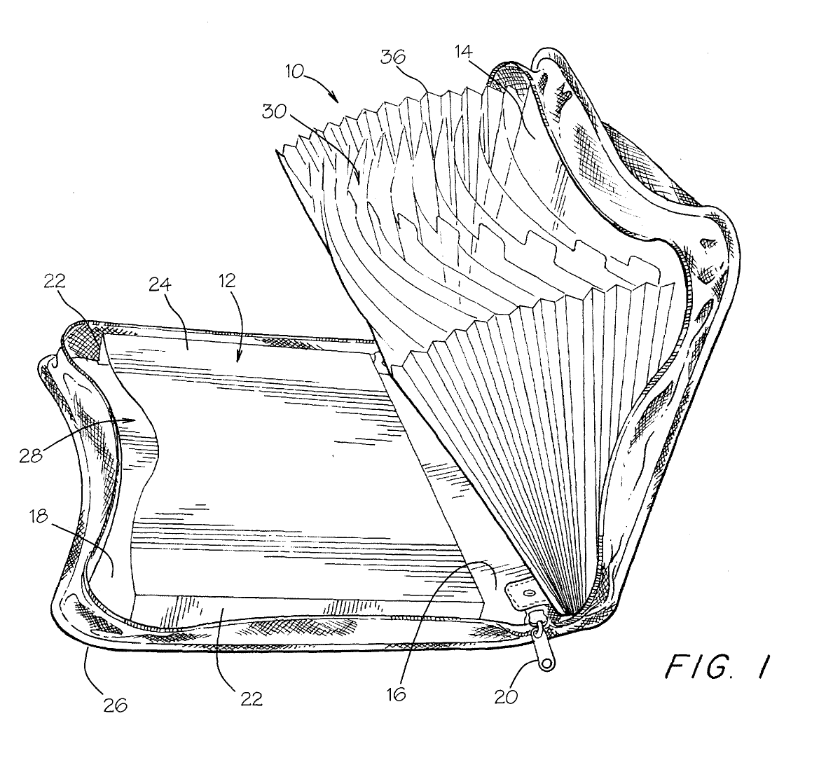

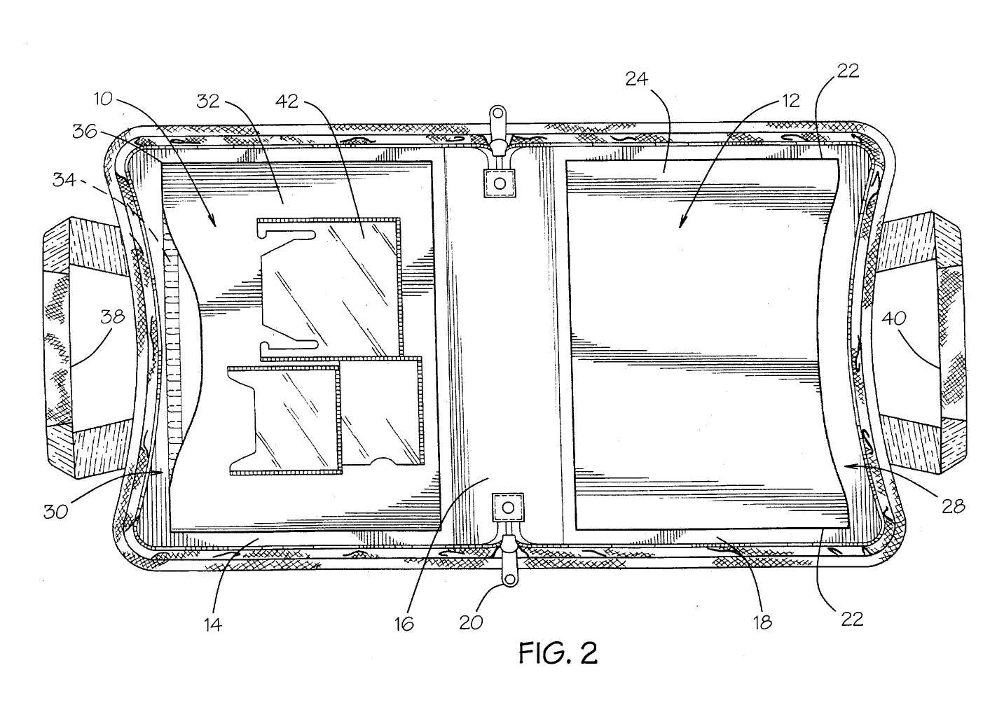

FIG. 1 is a perspective view of a container for organizing paperwork and the like, and more particularly of a system comprising an expandable file module 10 and a fixed document compartment 12 affixed to opposite sides of a sheet of material forming a document case. FIG. 2 is a plan view of the document case of FIG. 1.

The sheet of material includes a first side panel 14, a central section panel 16, and a second side panel 18 joined to form a bendable cover. Each panel has opposing exterior and interior surfaces. Exterior and interior are used to distinguish the portions of the panels that are on the outside and inside, respectively, of the closed document case.

The central section panel 16 is joined to an edge of each of the side panels 14, 18 along opposing edges of the central section panel. The joining may be a bendable score formed in a larger sheet of material or it may be a flexible connection between the individual panels to form a larger sheet. The side panels 14, 18 may fold at the joints with the central section panel 16 to allow the document case to close. The central section panel 16 of the document case may be bendable to allow the document case to close. When the document case is closed the interior surfaces of the side panels 14, 18 are in a facing relationship where the two interior surfaces are substantially parallel and spaced apart. A zipper closure 20 may couple the first side panel 14 to the second side panel 18 and hold the document case in the closed position. A pair of end panels 22 may join the interior surface 24 of the second side panel to the exterior surface 26 to create a fixed document compartment 28 in the second side panel 18. A first handle 38 may be connected to the first side panel 14 and a second handle 40 may be connected to the second side panel 18 to create a carrying grip when the document case is closed.

The document case includes an expandable file module 10. The expandable file in this embodiment is a thirteen pocket letter size file on a first side of the document case which opens to receive sheets along the length 30 of each pocket 36. Other embodiments may have a greater or lesser number of pockets and the pockets may open to receive sheets along the width of the pocket. The expandable file has a front surface 32 and a back surface 34. The pockets 36 are coupled to the front surface and the back surface to create a system of expandable interconnected pockets. A part of the first side panel 14 is the back surface 34 of the expandable file module 10. The front surface 32 of the expandable file module is not further connected to the document case. The front surface 32 may include pockets 42 for business cards, index cards, computer media, and the like.

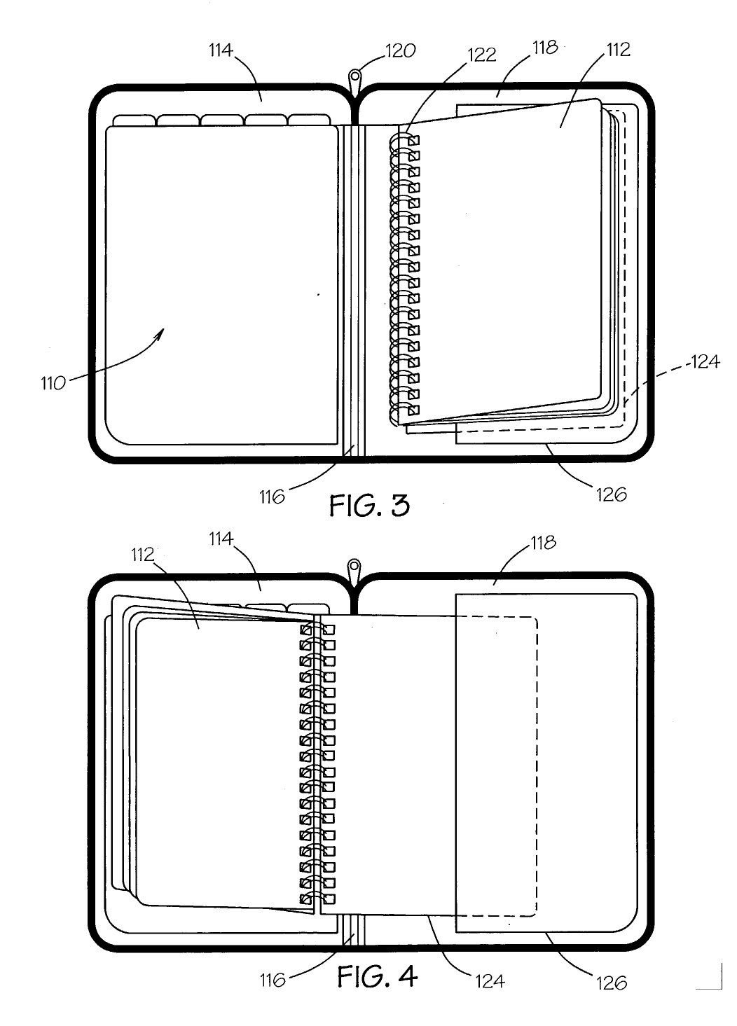

FIG. 3 is a perspective view of another embodiment of a document case. The expandable file 110 in this embodiment is a five pocket letter size file on a first side 114 of the document case which opens along the width of each pocket to receive sheets moved in a “vertical” direction. FIG. 4 illustrates insertion of a wire ring binder 112 having one cover 124 received in a pocket 126 on the second side 118 of the document case. A central section 116 of the document case is bendable to allow the document case to close. A zipper closure 120 maintains the case in a closed state. The binder rings 122 are not in the central area where the document case cover bends.

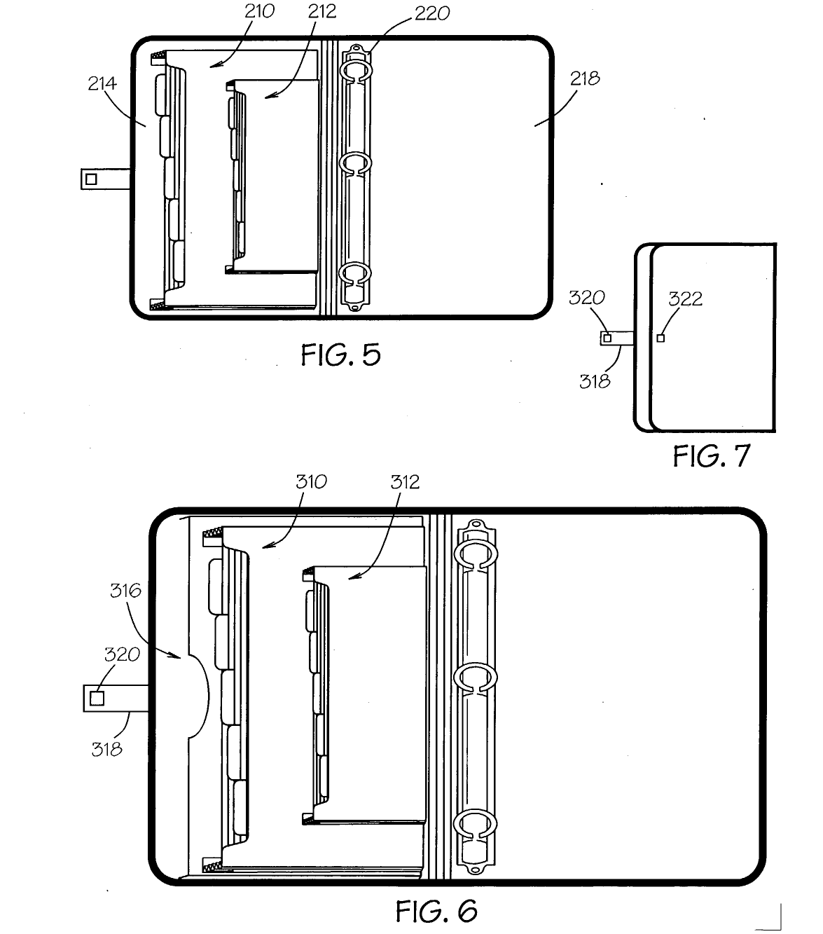

FIG. 5 is a perspective illustration of an embodiment of a document case including expandable files 210, 212 fixed to the first side 214 of the document case and receiving materials moved in a “horizontal” direction through openings along the length of each pocket. Installed on the second side 218 of the document case is a ring binder assembly 220.

In the embodiment of FIG. 6, a fixed document compartment 316 is fixed to the first side 314 of the document case and supports the expanding files 310, 312.

FIG. 7 illustrates the embodiment of FIG. 6 in a closed state. A strap 318 is attached to one of the side panels and may be fastened to the other side panel to provide a closure for the document case. Closure may be achieved with Velcro® strips 320, 322, for example. In other embodiments, snaps, buttons, and other temporary fasteners may be used.

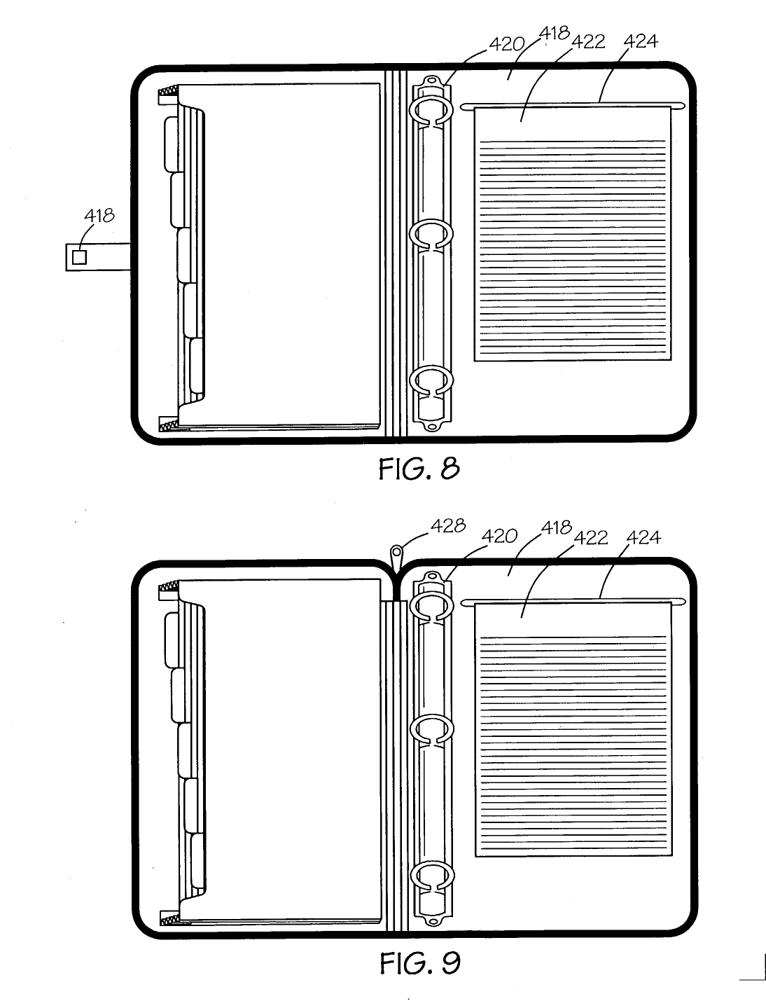

FIG. 8 and FIG. 9 each represent an embodiment including a ring binder assembly 420 in which a pad of paper 422 is retained on the second side 418 of the document case. A pocket 424 is formed in the second side 418 of the document case to receive the pad 422 moved in the “vertical” direction. When the document case is laid flat, and papers are retained in the ring binder assembly 420, the pad 422 will be under the pages in the binder. The illustration in FIGS. 8 and 9 respectively show Velcro® 426 and zipper 428 closures.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A document case comprising:
a first side panel that includes a first exterior surface and an opposing first interior surface of the document case;
a second side panel that includes a second exterior surface and an opposing second interior surface of the document case;
a central section panel joined to an edge of the first side panel along a first edge of the central section panel and joined to an edge of the second side panel along a second edge of the central section panel opposite the first edge, such that the first interior surface and the second interior surface may be brought into a facing relationship where the two interior surfaces are substantially parallel and spaced apart;
a closure that couples the first side panel to the second side panel and holds the first and second side panels in the facing relationship; and
a first expandable file module having a front surface and a back surface and a first plurality of interconnected pockets coupled to the front surface and the back surface, a part of the first side panel being the back surface of the first expandable file module, and the front surface being unconnected to the second panel.

2. The document case of claim 1, further comprising a second expandable file module having a front surface and a back surface and a second plurality of interconnected pockets coupled to the front surface and the back surface, a part of the front surface of the first expandable file module being the back surface of the second expandable file module, and the front surface of the second expandable file module being unconnected to the second panel.

3. The document case of claim 2, wherein the second expandable file module is for receiving smaller documents than the first expandable file module.

4. The document case of claim 1, further comprosing a pair of end panels that join the first interior surface to the first exterior surface to create a fixed document compartment in the first side panel.

5. The document case of claim 1, wherein the first plurality of interconnected pockets are open to receive documents along a pocket edge that is substantially parallel to the first edge of the central section panel.

6. The document case of claim 1, wherein the first plurality of interconnected pockets are open to receive documents along a pocket edge that is substantially perpendicular to the first edge of the central section panel.

7. The document case of claim 1, further comprising a pocket on the second side panel to receive a wire ring binder.

8. The document case of claim 1, further comprising a pocket on the second side panel to receive a pad of paper.

9. The document case of claim 1, further comprising a ring binder assembly coupled to the second panel.

10. The document case of claim 1, further comprosing a pair of end panels that join the second interior surface to the second exterior surface to create a fixed document compartment in the second side panel.

11. The document case of claim 1, wherein the closure is a Velcro® tab.

12. The document case of claim 1, wherein the closure is a zipper.

13. The document case of claim 1, further comprising a first handle coupled to the first side panel and a second handle coupled to the second side panel such that the document case can be carried by the first and second handles with the side panels in the facing relationship and the central section panel defining a bottom of the document case.

14. A document case comprising:
a first side panel;
a second side panel;
a central section means for joining the first side panel to the second side panel such that a surface of the first side panel and a surface of the second side panel may be brought into a facing relationship where the two surfaces are substantially parallel and spaced apart;
a closure means for coupling the first side panel to the second side panel and holding the first and second side panels in the facing relationship; and
a first expandable file means for receiving materials.

15. The document case of claim 14, further comprising a second expandable file means for receiving additional materials.

16. The document case of claim 15, wherein the material received by the first expandable file means can be larger than the additional material received by the second expandable file means.

17. The document case of claim 14, wherein the first side panel further includes a document compartment means for supporting the first expandable file means.

18. The document case of claim 14, further comprising a pocket means for receiving a wire ring binder.

19. The document case of claim 14, further comprising a pocket means for receiving a pad of paper.

20. The document case of claim 14, further comprising a ring binder means for retaining papers.

21. The document case of claim 14, further comprising handle means for carrying the document case with the side panels in the facing relationship.
